(19) United States
(12) Patent Application Publication
(10) Pub. No.: US 2013/0035974 A1
(43) Pub. Date: Feb. 7, 2013

(54) SYSTEMS, METHODS, AND COMPUTER-READABLE MEDIA FOR INNOVATION CO-CREATION

(71) Applicants: Sougata Ray, West Bengal (IN); Anjan Ghosh, Kolkata (IN)

(72) Inventors: Sougata Ray, West Bengal (IN); Anjan Ghosh, Kolkata (IN)

(73) Assignee: INFOSYS LIMITED, Bangalore (IN)

(21) Appl. No.: 13/330,122

(22) Filed: Dec. 19, 2011

(30) Foreign Application Priority Data
Aug. 1, 2011 (IN) 2635/CHE/2011

(51) Int. Cl. G06Q 10/06

(52) U.S. Cl. 705/7.14

(57) ABSTRACT

Systems, methods, and computer-readable code stored on a non-transitory media for creating an innovation co-creation ecosystem by one or more computing devices, including designing an innovation co-creation ecosystem for an innovation drive by a primary innovator; providing a co-creation constituent selection framework configured to assist the primary innovator with selection of a set of co-creation constituents; and hosting the innovation co-creation ecosystem.

### RELATED APPLICATION DATA

This application claims priority to Indian Patent Application No. 2635/CHE/2011, filed Aug. 1, 2011, which is hereby incorporated by reference in its entirety.

### BACKGROUND

In this competitive world, success of an entity often depends on its power to innovate. However the parameters, if not the very definition, of innovation have changed. The competitive world is now driven by a model where every client desires entities they work with to take care of their unique needs while resourcing has become global. As the world becomes flat and global resources become accessible and available, the competitive advantage for organizations lie in understanding the need to get connected—get connected to the appropriate resources quickly, get connected to the resources best suited to its business scenario, protect their interests in the open and over-exposed work, establish trusted relationships with entities which would be mutually beneficial, manage such relationships, and managing workflows unique to the relationships.

In recent years, the applications of social networks and business networks have increased manifold. Such an increase has provided for greater applications for innovation co-creation systems Innovation co-creation systems are systems that may enhance strategic capital, increase returns, and expand market opportunities by allowing an organization to improve upon portions of the innovation lifecycle. The innovation lifecycle may include inspiration, idea generation, idea selection, idea incubation, and finally commercialization. Stakeholders may be any entity a company may look to for possible contribution to the innovation process. For example, if a company's objective is to “inspire a group to generate ideas”, the company may look outside of the company for possible contribution, for example, to identify the right area of interest, to identify possible partners who can be part of the idea generation group, to identify a partner who can ‘generate’ the inspiration or can provide consulting on the ways to inspire or sensitize the group or even to manage the ‘inspiration’ process, and the like. These entities may form an innovation co-creation network or sub-network. Similarly, other sub-networks may exist for all phases of the innovation lifecycle.

However, current technologies are limited to architectures of systems to co-create with other co-creation constituents, both external and internal to the organization leading the innovation. For example, Document eRoom by EMC™ provides a collaboration system on which constituents can collaborate. By way of alternative example, Tacit Software (now integrated in the ORACLE™ Beehive platform) provides a standards-based enterprise collaboration platform.

Likewise, technologies and solutions exist that attempt to find co-creation partners for primary innovators. For example, INNOCENTIVE™ provides a system that allows primary innovators to post a problem and invites interested parties (i.e., potential innovation co-creation constituents) to present suitable solutions. Based on the responses from the interested parties, the primary innovators may identify and engage appropriate partners for innovation co-creation. Similarly, Tata Consulting Services Limited offers a Co-Innovation Network (“COIN™”) system that attempts to find appropriate co-creation constituents for primary innovators from their databases. NineSigma, Inc. also offers open innovation (“OI”) services aimed at locating potential co-creation partners for a primary innovator, evaluating the partners, and negotiating a co-creation partnership.

### BRIEF DESCRIPTION OF THE DRAWINGS

FIG. 1 shows an exemplary process flow for creating an innovation co-creation ecosystem.

FIG. 2 shows an exemplary process flow for performing a requirements analysis function.

FIG. 3 shows an exemplary process flow for a constituent profiling function.

FIG. 4 shows a functional block diagram of a connect strategy and various strategic sub-processes of the connect strategy.

FIG. 5 shows a functional block diagram of an exemplary constituent search function.

FIG. 6 shows an exemplary process flow for a primary innovator to engage with a potential co-creation constituent.

FIG. 7 shows an exemplary computing device useful for performing processes disclosed herein.

FIG. 8 shows an exemplary architecture for hosting and/or managing an innovation co-creation ecosystem.

FIG. 9 shows an exemplary conceptual diagram of an innovation co-creation ecosystem.

FIG. 10 shows an exemplary multi-tiered innovation co-creation ecosystem.

While systems, methods, and computer-readable media are described herein by way of examples and embodiments, those skilled in the art recognize that innovation co-creation and knowledge orchestration is not limited to the embodiments or drawings described. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include”, “including”, and “includes” mean including, but not limited to.

### DETAILED DESCRIPTION

As described in the background, existing innovation co-creation solutions are limited to either providing space or a platform as an interface for the primary innovator and co-creation constituents to engage and manage the innovation co-creation or finding suitable co-creation partners for a primary innovator through a handful of methods (e.g., online search, online bidding, request for proposal (“RFP”) management, etc.). However, the innovation process begins long before these current solutions, namely at the innovation inspiration phase, and extends beyond current solutions, ultimately to commercialization. No comprehensive system exists today which can support end-to-end activities related to the design, formation, management, and assessment of an innovation co-creation ecosystem. Specifically, current solutions fail to address the initial parts (i.e., designing a custom innovation co-creation system) and final parts (i.e., value assessment and performance assessment of the innovation co-creation system) of an innovation co-creation ecosystem.

Disclosed embodiments provide systems, computer-implemented methods, and computer-readable media for designing, forming, hosting, and assessing a custom innovation co-creation ecosystem. Such embodiments may be configured to assess the innovation co-creation readiness of an organization, design an innovation co-creation ecosystem for the organization customized for an innovation drive, provide framework for the organization to find, select, and engage with co-creation constituents, host and manage the custom innovation co-creation ecosystem, and assess value and performance of the custom innovation co-creation ecosystem.

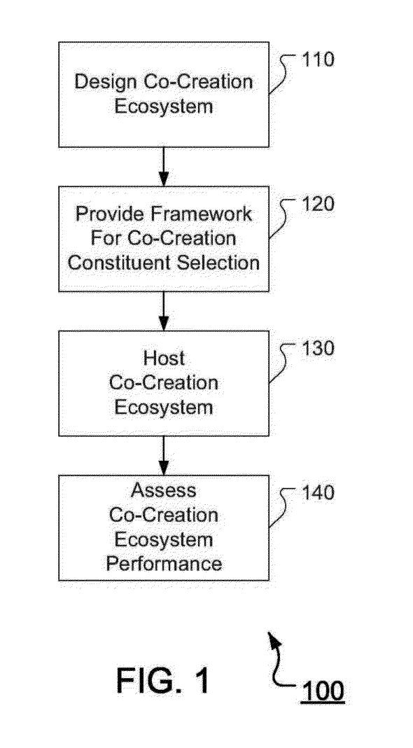

FIG. 1 illustrates an exemplary process flow 100 for creating an innovation co-creation ecosystem. At step 110, a service provider may assess a primary innovator's innovation needs and design an innovation co-creation ecosystem according to such needs. The innovation co-creation ecosystem may be customized to the innovation drive the primary innovator aspires to achieve. Functions performed by the service provider at step 110 may include, for example, assessing the co-creation readiness of a primary innovator, determining an architecture for the ecosystem, profiling potential ecosystem co-creation constituents, determining a co-creation constituent approach strategy, budgeting, and like functions. At step 120, the service provider may provide a framework for the primary innovator to select co-creation constituents. The selection framework may assist with identifying potential co-creation constituents, selecting and approaching potential co-creation constituents, negotiating agreements with constituents, and the like. At step 130, the service provider may host the innovation co-creation ecosystem by leveraging communication and social networking technologies to provide a collaborative platform. At step 140, the service provider may assess the ecosystem performance and value, for example by monitoring and evaluating various data measures.

Of course, process flow 100 is divided into discrete steps for ease of illustration only. Embodiments may combine or subdivide one or more steps of process flow 100 without deviating from this disclosure. Additionally, the various steps of process flow 100 may include one or more functions disclosed herein. Each of the steps and/or functions may be embodied in software modules stored on non-transitory media to be executed by one or more computing devices, for example each step and/or function may be a module executed by a computing device.

Step 110 of process flow 100 may include a readiness analysis function configured to assess the innovation co-creation readiness of the primary innovator from various possible aspects. The readiness analysis function may survey the primary innovator and perform various analytics on survey results to determine innovation co-creation readiness of the primary innovator. For example, the readiness analysis function may assess the current infrastructure of the primary innovator to determine if the current infrastructure is amenable to innovation co-creation or if it may be adapted to better be aligned with an innovation co-creation ecosystem. The readiness analysis function may likewise assess the financial state, the legal status, and the like of the primary innovator to determine co-creation readiness. The readiness analysis functions may be performed in an automated fashion, for example by implementing various lookup tables, fuzzy logic, and the like, in a manual fashion by providing co-creation readiness survey results to one or more co-creation readiness assessment agents (e.g., analysts, accountants, lawyers, etc.), or in a hybrid fashion utilizing both automated and manual aspects (e.g., using manual analysis to confirm automated analysis, using manual analysis if the automated analysis has a confidence value below a determined threshold, and the like). The readiness analysis function may then provide a report or recommendation to the primary innovator including an interpretation of its co-creation readiness to assist the primary innovator with determining strategy and next steps for potential innovation co-creation. As described below, a similar function may determine the readiness analysis of potential co-creation constituents.

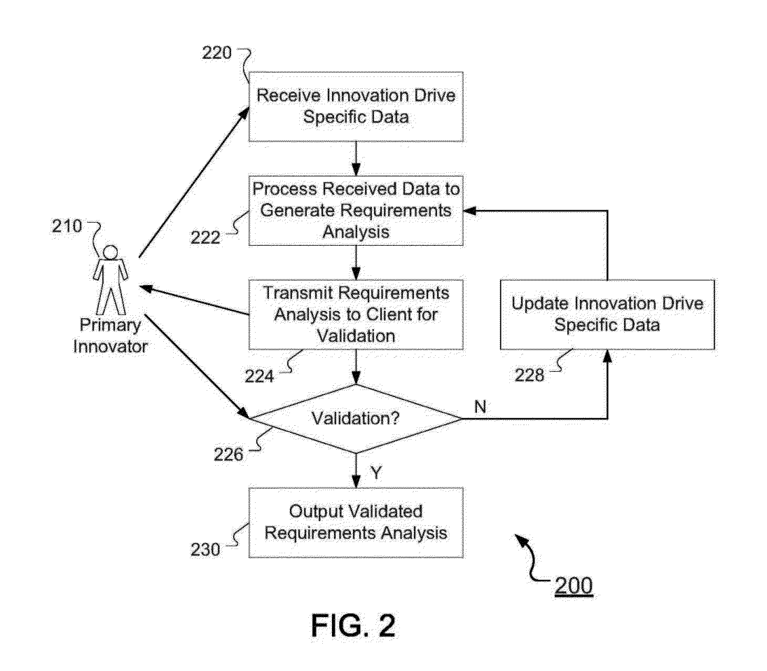

Step 110 of process flow 100 may also include a requirements analysis function configured to assess the innovation co-creation requirements for an innovation drive. FIG. 2 shows an exemplary process flow 200 for performing a requirements analysis function. At step 220, one or more computing devices of a service provider may receive client specific innovation drive data from a primary innovator 210. A service provider computing device may, for example, provide a survey to primary innovator 210 and, in response, receive information on the innovation drive. Alternatively, primary innovator 210 may send the service provider a briefing on the innovation drive. The innovation drive specific data received at step 220 may include, for example, the type of innovation desired, the technology domain for the innovation, the current phase of the innovation (inspiration, development, commercialization, etc), type of engagements expected, type of innovation co-creation constituent expected or preferred, budget (if any), value sharing model (if any), and the like.

Independent of how the service provider's computing system receives the innovation drive specific data at step 220, at step 222 the system may process the received data to generate a co-creation requirements analysis report. The co-creation requirements analysis report may both provide a summary of the service provider's understanding of the primary innovator's innovation drive and a summary of requirements necessary to pursue the innovation drive via an innovation co-creation ecosystem. At step 224, a service provider's computing device may transmit the requirements analysis to the primary innovator to allow the primary innovator to validate (e.g., sign-off on) the generated requirements analysis. At step 226, a computing device may receive a validation indication (e.g., an indication whether the primary innovator validated the requirements analysis or not) and determine next steps in the process flow. At step 226, a computing device may also receive modifications to the requirements analysis or other innovation drive data from the primary innovator.

If the primary innovator did not validate the innovation drive requirements analysis at step 226, process flow 200 may proceed to step 228 and the received data may then be updated in accordance with the additional innovation drive data received from primary innovator 210. Process flow 200 may then iteratively repeat steps 222, 224, and 226 until a positive validation is received from the primary innovator. Once a positive validation is received form the primary innovator at step 226 (including the first time step 226 is reached if primary innovator 210 provides a primary validation after receiving a first requirements analysis), process flow 200 may proceed to step 230 and output the validated requirements analysis for use by down-stream functions and/or modules.

Of course, alternative embodiments may combine, subdivide, or omit one or more steps of process flow 200. For example, while process flow 200 includes validation related steps 224, 226, and 228, alternative embodiments may omit such steps. Process flow 200 may also include one or more additional steps for performing additional functions.

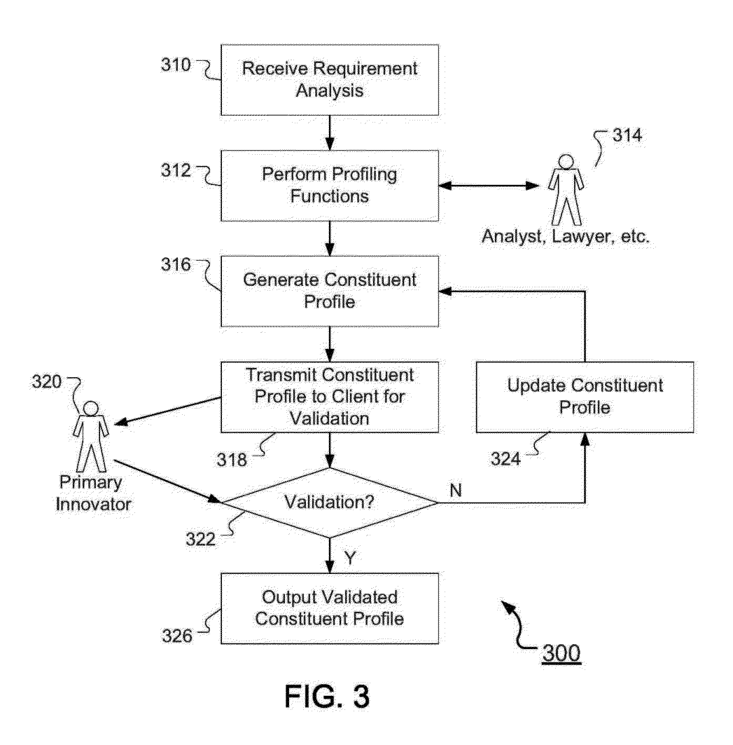

Referring again to process flow 100 of FIG. 1, the design co-creation specific ecosystem step 110 may also include a constituent profiling function. FIG. 3 shows an exemplary process flow 300 for a constituent profiling function. At step 310, a computing device may receive a requirements analysis for an innovation drive. The received requirements analysis may, for example, be the requirements analysis output at step 230 of process flow 200 discussed above. At step 312, a computing device may then perform one or more functional and domain profiling functions. Step 312 may include profiling a potential constituent's capability to participate in innovation co-creation, technology capabilities, involvement in relevant business domains, involvement in key discipline areas, proficiency level in various spaces (which may include best practices proficiency levels), available tools and technologies, assessment and assurance of quality, and security policies. Profiling at step 312 may also include non-functional profiling. Non-functional profiling metrics for a potential constituent may analyze factors including location, type of organization, organization financial strength, the organization's potential interest in the innovation drive, the organization's infrastructure, the organization's corporate policies (e.g., supporting diversity), the organization's value sharing model, and potential liability of involving the potential constituent in a co-creation ecosystem. Further still, step 312 may include a feasibility analysis which may take into consideration, for example, potential legal, physical, technical, and economic consequences of partnering with the potential constituent in an innovation co-creation ecosystem as well as potential alternative options. Step 312 may be performed in an automated fashion by one or more computing devices, may be performed manually by one or more people or organizations 314 (e.g., analysts, lawyers, accountants, engineers, etc.), or may be performed by a hybrid of automated and manual systems.

At step 316, a computing device may generate a constituent profile for a potential constituent based on the profiling performed at step 312. At step 318, a computing device may then transmit the constituent profile to the primary innovator for validation of accuracy of the profile. The primary innovator 320 may either validate the constituent profile or correct any inaccuracies. For example, the primary innovator may indicate that a potential constituent should have differing corporate policies than those indicated in the initially generated constituent profile. At step 322, a computing device may either receive validation of the constituent profile or receive an indication that the constituent profile is not validated. If the constituent profile is not validated, at step 324 the system may update the constituent profile, for example in view of corrected constituent information received at step 322 from the primary innovator 320. After step 324, steps 316, 318, and 322 may be iteratively repeated until the primary innovator 320 validates a constituent profile at step 322. Once the constituent profile is validated, the process flow 300 may proceed to step 326 and output the validated constituent profile to downstream systems.

Of course, alternative embodiments may combine, subdivide, or omit one or more steps of process flow 300. For example, while process flow 300 includes validation related steps 318, 322, and 324, alternative embodiments may omit such steps. Process flow 300 may also include one or more additional steps, such as steps for determining a potential constituent's co-invention readiness. Such a function may be performed in similar fashion to the above described function for determining a primary innovator's co-creation readiness. This may be, for example, part of the profiling function at step 312. Alternatively, a potential constituent's co-creation readiness may be determined prior to process flow 300 and the potential constituent may only be subject to process flow 300 if a threshold co-creation readiness value is achieved.

Referring again to step 110 of process flow 100, a risk profiling and mitigation plan function to plan for potential risks a primary innovator may face with regard to innovation co-creation. Such a function may receive the constituent profile from step 326 of process flow 300 and analyze probable and/or possible risks that could arise out of an innovation partnership between the primary innovator and the potential co-creation constituent. The risk profiling and mitigation plan function may then develop one or more mitigation strategy to implement in case the identified risks become problems. The function may also take proactive steps to minimize or mitigate potential risks. For example, steps may be taken to identify and protect intellectual property developed by the primary innovator prior to disclosing any potential intellectual property to potential co-creation constituents.

The risk profiling and mitigation function may be performed in an automated fashion by identifying potential risks and suggesting potential steps to minimize or mitigate the risks. Alternatively, the function may be implemented in a manual fashion. For example, the service provider may provide a workshop for the primary innovator and optionally one or more co-creation constituents. Such a workshop, for example, may include specialists on innovation co-creation requirements, specialists in risk profiling for innovation co-creation, one or more representatives of the primary innovator (e.g., sponsors of the innovation, functional contributors, in-house or outside legal representatives, information technology representatives, etc.), and in some instances one or more representatives of one or more potential constituents.

Referring again to process flow 100, step 120 may include functions for developing a strategy for connecting a primary innovator with potential co-creation constituents, allowing a primary innovator to search for and identify potential co-creation constituents, and allow a primary innovator to connect with co-creation constituents. Of course, additional functions may be included in step 120 or some of these functions may be performed in other steps of process flow 100 or omitted altogether.

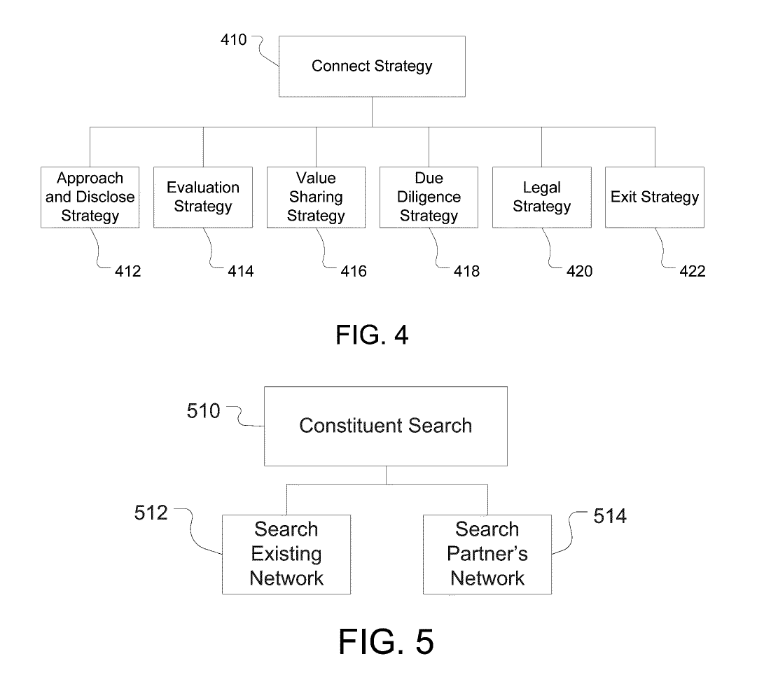

FIG. 4 shows a functional block diagram 400 of a connect strategy 410 and various strategic sub-processes of the connect strategy 412-422. The connect strategy 410 may define a strategy to be used by the primary innovator to connect with potential co-creation constituents in a co-creation network. To develop a connect strategy 410, a primary innovator may provide a broad strategy framework to the service provider and the service provider may customize it for the innovation specific environment and/or need.

One sub-process of connect strategy 410 may be an approach and disclose strategy 412 sub-process. Unlike a standard vendor connect, embodiments may provide that a primary innovator's identity may remain undisclosed until a potential constituent expresses a threshold degree of interest and agrees to a high-level structure of an innovation co-creation engagement. Approach and disclosure sub-process 412 may additionally include steps to conceal (i.e., avoid from disclosing) various aspects of the innovation conception/idea so that aspects of the idea may be initially concealed from disclosure to potential co-creation constituents. In other words, this sub-process may include careful planning to only disclose aspects of an innovation drive that could not compromise intellectual property protection or other market competitive advantages at early stages of potential constituent selection. The connect strategy 410 may include a legal strategy sub-process 420 for preparing a nondisclosure agreement (“NDA”) template for potential co-creation constituents to execute before full details of an innovation drive may be divulged by the primary innovator.

The connect strategy 410 may also include an evaluation strategy sub-process 414. The evaluation strategy sub-process 414 may include various steps for the primary innovator to evaluate one or more potential co-creation constituents. The connect strategy 410 may also include a value sharing strategy sub-process 416 for defining the approach of the primary innovator toward disclosing and/or initiating the discussion of possible value sharing with potential co-creation constituents. The evaluation strategy sub-process 414 may include a simple transaction or financial model and/or in some cases it may involve discussion of possible value generation out of the innovation drive and potential ways to share value between the primary innovator and co-creation constituents. Such a strategy discussion may involve participation from legal and financial departments of the primary innovator. The outcome of the evaluation strategy sub-process 414 may be a potential value sharing model for engagement with a co-creation constituent. Of course, the value sharing model may include alternative options that may be selected at time of engagement between the primary innovator and a co-creation constituent. Additionally, the value sharing model may be modified at the time of engagement between a primary innovator and a co-creation constituent.

Connect strategy 410 may also include a due diligence strategy sub-process 416. This sub-process may include various metrics to measure a potential co-creation constituent against to determine whether engagement would be beneficial for the specific innovation drive. Connect strategy 410 may finally include an exit strategy sub-process 422 configured to enable the primary innovator to exit the potential engagement at any point during the discussion and/or exploration related phases. The exit strategy may include planning various communications that should be involved in formally closing discussions with a potential co-creation constituent.

Referring again to process flow 100, step 120 may include a constituent search function. FIG. 5 shows a functional block diagram of an exemplary constituent search function 510. Constituent search function 510 may include logic to identify potential co-creation constituents having profiles that match the constituent profile output from process flow 300. In functional block 512, the service provider may allow a primary innovator to search the primary innovator's existing network of co-creation constituents to determine whether any existing co-creation constituents have a profile matching or similar to the co-creation profile generated for the current innovation drive. Alternatively, functional block 514 may provide for a primary innovator to search one or more partners' networks for potential co-creation constituents having profiles matching or similar to the innovation drive specific co-creation profile. The partners' networks may be, for example, the networks of existing co-creation constituents involved in other innovation drives, networks of the service provider, or any other networks of potential co-creation constituent profiles. For example, various sources may provide datasets of profiles of potential co-creation constituents and the sources may query against the dataset to determine potential co-creation constituents having profiles matching the constituent profile for the innovation drive.

Referring again to process flow 100, at step 120 after a primary innovator selects potential co-creation constituents the primary innovator may implement one or more engagement model to engage (i.e., connect) with one or more of the potential co-invention constituents. Embodiments provide for the engagement to be explored under a secured environment so that various details of an innovation drive, of the primary innovator's identity, of a potential co-creation constituent's identity and the like may only be revealed at appropriate times. In this fashion, intellectual property may remain secure by not disclosing details of the innovation drive prior to execution of an appropriate NDA or other agreement. Additionally, such a model allows amicable termination of the engagement if any party decides not to pursue a co-creation engagement, for example due to a conflict of interest or due to a disagreement with regard to terms and conditions (e.g., value sharing) of the engagement.

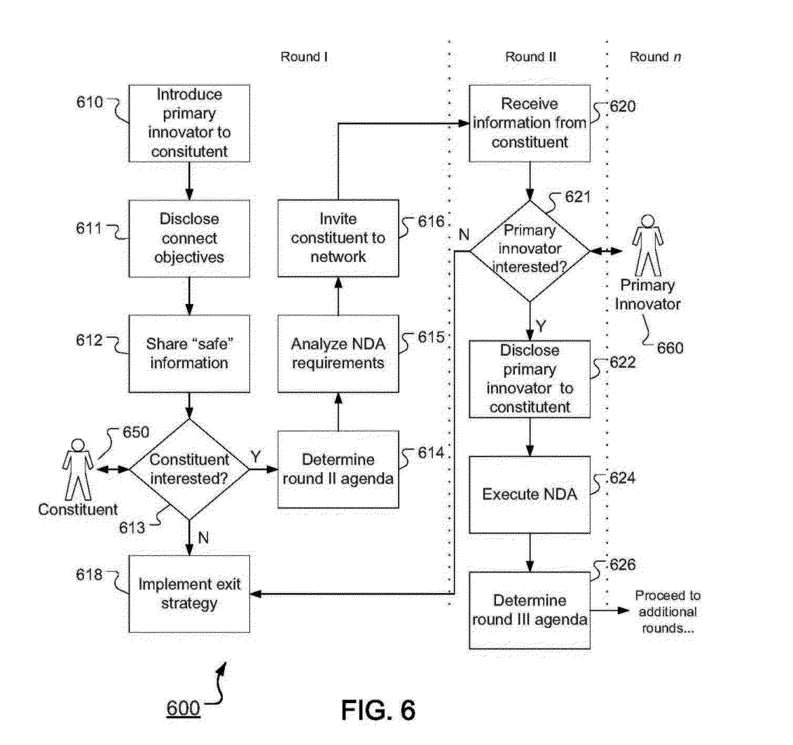

FIG. 6 shows an exemplary process flow 600 for a primary innovator to engage with a potential co-creation constituent, such as a co-creation constituent identified by the constituent search function described above. A first round of engagement discussion may start with step 610 in which the primary innovator may be introduced to a potential co-creation constituent. At step 610 various details of both the primary innovator and the potential co-creation constituent may be concealed, thereby aiding in amicable dissolution of the discussion should either the primary innovator or the potential co-creation constituent decide to pull itself off (i.e., exit) the discussion. At step 611, the objectives of the co-creation connection may be disclosed to the potential co-creation constituent. Such details may include, for example, an explanation of the goals of a co-creation engagement, details of the network or architecture of the ecosystem to be used for co-creation, and the like. At step 612, “safe” information relating to the innovation drive may be shared with the potential co-creation constituent. The “safe” information may be general information that does not run a risk of waiving any intellectual property rights or giving up competitive advantage in the marketplace to the potential co-creation constituent. Such information may include a description of the domain (e.g., technology space) of the innovation drive, basic background information of the business of the primary innovator, general information regarding the innovation drive, and the like. The primary innovator may approve of any information prior to disclosure to a potential co-creation constituent. At step 613, a computing device may survey the potential co-creation constituent 650 to determine if the potential co-creation constituent 650 is interested based on the high level information relating to the innovation drive disclosed in the first round of discussions.

If the potential co-creation constituent 650 is not interested, the process flow may proceed to step 618 and the primary innovator may implement their exit strategy. Otherwise, if the potential co-creation constituent is interested, the process flow may proceed to step 614 and the primary innovator and the potential co-creation constituent may determine an agenda for a second round of discussions. At step 615, the parties may analyze whether the second round of discussions requires an NDA or any other types of legal agreement and, if appropriate, prepare and execute such agreements. At step 616, the primary innovator may then invite the potential co-creation constituent to join the primary innovator's network at a co-creation constituent. The network may be any type of architecture configured to provide for collaboration between the primary innovator and one or more co-invention constituent.

In a second round of the discussion, more details may be disclosed with regard to the identity of the primary innovator, the identity of the co-creation constituent, and the innovation drive. At step 650, the primary innovator may receive various details from the co-creation constituent. Such details may include the identity of the co-creation constituent, detailed background of the co-creation constituent's experience and capabilities in the technology space of the innovation drive (i.e., functional competency), the non-functional environment of the co-creation constituent, the co-creation constituent's thoughts on the first round of discussion based on the details of the innovation drive disclosed to them, potential concerns of the co-creation constituent (e.g., potential conflicts of interest), and constituent assurances on disclosure and information security. At step 621, the information form the co-creation constituent may be passed to the primary innovator 660 and the primary innovator may indicate whether they are interested in proceeding with discussions. If not, the process flow may proceed to step 618 and the primary innovator may implement their exit strategy. Otherwise, the process flow may proceed to step 622 and the identity of the primary innovator may be disclosed to the co-creation constituent. At step 624, if no engagement agreement or NDA has been executed, one may be executed by both the primary innovator and the co-creation constituent. In some embodiments a first agreement may be executed in the first round of discussion relating to the limited disclosure to happen in the second round and then, in step 624, a more complete agreement may be executed relating to the specific innovation drive that the co-creation relationship supports. At step 626, the primary innovator and the co-creation constituent may determine an agenda for the third and/or any additional rounds of discussion.

Embodiments of process flow 600 may provide for both the primary innovator and the co-creation constituent to deal directly with a service provider so that details of the primary innovator and the co-creation constituent may remain hidden in early rounds of discussion. From step 626 onwards, the primary innovator may become the moderator and discussion may happen in a more open forum. Of course, in other embodiments more or less rounds of discussion may take place before the co-creation parties may interact across an open forum.

In additional rounds of discussion, a service provider may provide the primary innovator with a network to provide the necessary secured technology platform to manage the workflow of co-creation. The workflow may advance according to the strategy and design of the primary innovator. These additional rounds may include disclosing specific details of the innovation drive.

While process flow 600 provides plural steps that specifically allow either the primary innovator and/or the co-creation constituent to break discussion and terminate the engagement, embodiments may allow either party can break discussion at any time. By providing a secure environment, in early rounds of discussion the engagement may be terminated without the co-creation constituent knowing sufficient details of the innovation drive or the primary innovator to have a negative effect on the primary innovator's market position or intellectual property rights. Likewise, as the discussion progresses, agreements are put in place (e.g., NDAs) to ensure that any disclosed information is safe.

Referring again to process flow 100, at step 130 the service provider may host the primary innovator's co-creation ecosystem. This may involve hosting an internet based architecture to allow for collaboration between a primary innovator and one or more co-creation constituents. For example, the ecosystem may allow for plural co-creation constituents to be on-boarded according to process flow 600.

At step 130, the service provider may additionally manage the co-creation ecosystem. In other words, ecosystem provided by the service provider may have its own dynamics. Based on the requirement of an innovation, an ecosystem (e.g., a micro ecosystem) may be created from a macro ecosystem. The activities related to the macro ecosystem may involve performing a requirement analysis, sourcing (e.g., finding and selecting co-creation constituents) on-boarding/exiting, accessing the performance of the micro ecosystem, and the like.

Referring again to process flow 100, at step 140 the service provider may assess the co-creation ecosystem performance. Step 140 may include providing a value assessment of the innovation co-creation drive. A value assessment may measure the performance of the co-creation network services, for example on a real-time or near real-time basis. Any or all parties involved in an innovation co-creation ecosystem may desire to know the value that a co-creation initiative and a co-creation environment create for them. Thus, embodiments may track the value creation process through various assessments (e.g., by quantifying the values, tracking the values, and finally assessing the values). An innovation co-creation ecosystem may, for example, track the objective of each primary user group in joining the ecosystem or a co-creation drive; quantify the objectives of each primary user group by converting the objective to measurable goals and objectives, map the right elements to the goals and objectives (e.g., mapping the financial software to performance goals, creating surveys, and mapping those with population for satisfaction related goals, and the like), define tracking mechanisms (e.g., for tracking goals and plans), collect data, and analyze the data.

While process flow 100 shows step 140 commencing after the termination of step 130, embodiments may perform 140 periodically while performing step 130 to assess the performance of the ecosystem. In other embodiments, step 130 may be performed substantially in real-time during the entire pendency of step 130. Additionally, step 120 may be performed plural times during execution of step 130. In this fashion, the primary innovator may add one or more additional co-creation constituents to an existing co-creation ecosystem.

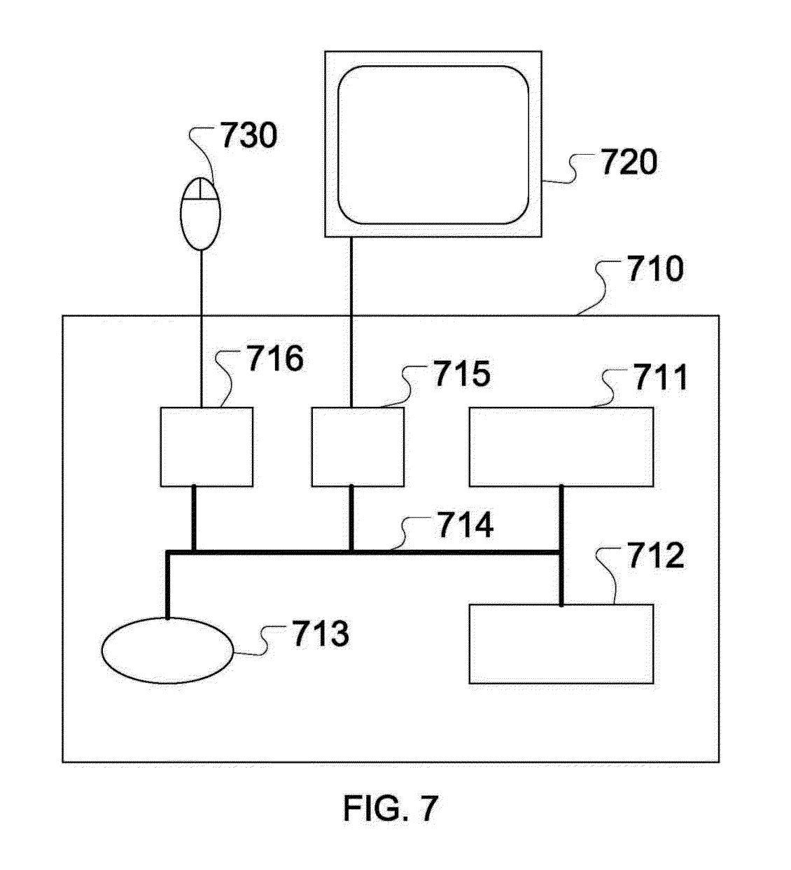

These embodiments may be implemented with software, for example modules executed on computing devices such as computing device 710 of FIG. 7. Of course, modules described herein illustrate various functionalities and do not limit the structure of any embodiments. Rather the functionality of various modules may be divided differently and performed by more or fewer modules according to various design considerations.

Computing device 710 has one or more processing device 711 designed to process instructions, for example computer readable instructions (i.e., code) stored on a storage device 713. By processing instructions, processing device 711 may perform the steps and functions disclosed herein. Storage device 713 may be any type of storage device (e.g., an optical storage device, a magnetic storage device, a solid state storage device, etc.), for example a non-transitory storage device. Alternatively, instructions may be stored in one or more remote storage devices, for example storage devices accessed over a network or the internet. Computing device 710 additionally may have memory 712, an input controller 716, and an output controller 715. A bus 714 may operatively couple components of computing device 710, including processor 711, memory 712, storage device 713, input controller 716, output controller 715, and any other devices (e.g., network controllers, sound controllers, etc.). Output controller 715 may be operatively coupled (e.g., via a wired or wireless connection) to a display device 720 (e.g., a monitor, television, mobile device screen, touch-display, etc.) in such a fashion that output controller 715 can transform the display on display device 720 (e.g., in response to modules executed). Input controller 716 may be operatively coupled (e.g., via a wired or wireless connection) to input device 730 (e.g., mouse, keyboard, touch-pad, scroll-ball, touch-display, etc.) in such a fashion that input can be received from a user.

Of course, FIG. 7 illustrates computing device 710, display device 720, and input device 730 as separate devices for ease of identification only. Computing device 710, display device 720, and input device 730 may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing device 710 may be one or more servers, for example a farm of networked servers, a clustered server environment, or a cloud network of computing devices.

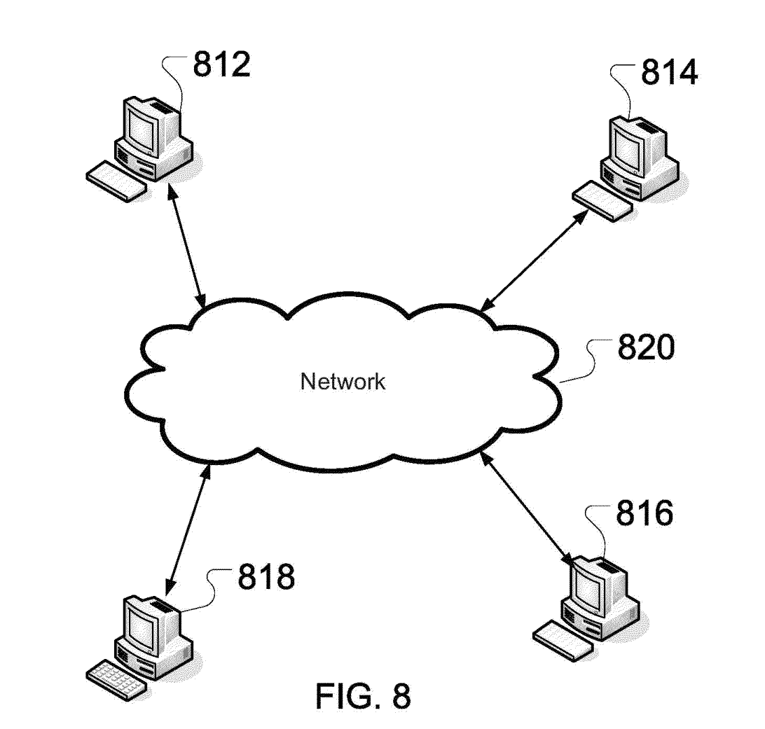

Embodiments disclosed herein generally refer to hosting and managing of a co-creation ecosystem by a service provider. However, in alternative embodiments other entities may host and/or manage a co-creation ecosystem. FIG. 8 shows an exemplary architecture for hosting and/or managing an innovation co-creation ecosystem. In FIG. 8, one or more computing devices 812 may correspond to the owner and/or creator of the technology supporting an innovation co-creation ecosystem, one or more computing devices 814 may correspond to one or more primary innovators, one or more computing devices 816 may correspond to one or more possible contributors (i.e., co-creation ecosystem constituents), and one or more computing devices 818 may correspond to one or more service providers (i.e., organizations which offer services related to co-creation ecosystem. The computing devices 812, 814, 816, and 818 may be operatively coupled via a network 820 (e.g., the internet). Computing devices 812, 814, 816, and 818 may represent both potential users of an innovation co-creation ecosystem as well as potential hosts of such a system.

An innovation co-creation ecosystem as disclosed herein may include software executed on hardware (e.g., a server). The software can then be accessed via various network technologies. The hardware may be one or more computing device corresponding to, for example, any of the computing devices shown in FIG. 8.

In one embodiment, an innovation co-creation ecosystem may be hosted by one or more computing device 812 corresponding to the owner and/or creator of the technology. For example, the computing device 812 may execute code and provide licenses to the primary innovator (so that it can create its customized innovation co-creation ecosystem) and to service providers. The service providers may use the ecosystem to provide various services to the primary innovator and may also create and manage ‘micro ecosystems’ for its clients.

In other embodiments, a system may be hosted by a computing device 814 corresponding to a primary innovator or a computing device 818 corresponding to one or more service providers. When hosted by a computing device 818 corresponding to one or more service providers, the service providers may then create and host a macro ecosystem that may offer various services to the primary innovators.

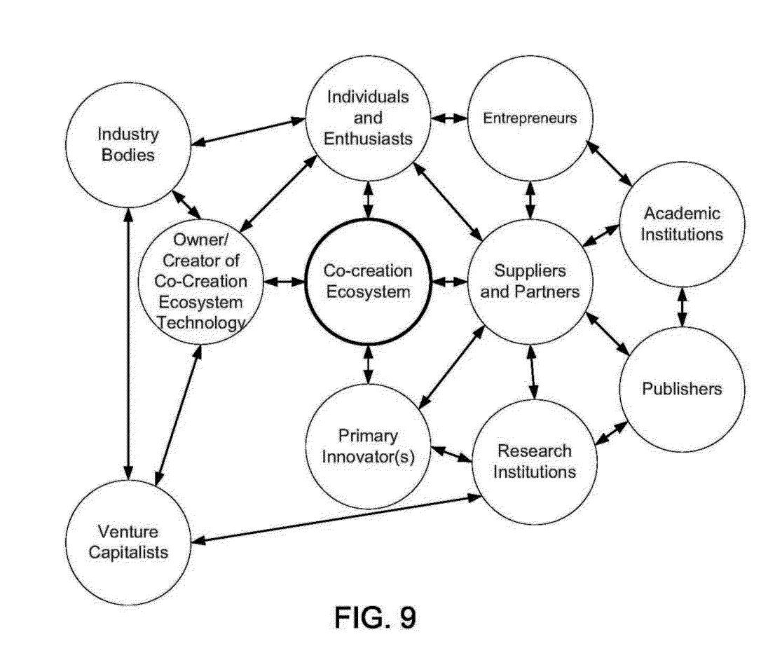

FIG. 9 shows an exemplary conceptual diagram of an innovation co-creation ecosystem. The co-creation ecosystem may connect one or more primary innovators with various entities that would contribute to the primary innovator's innovation drive. The co-creation ecosystem may provide end-to-end support to any phase of the innovation cycle by finding and connecting the appropriate entities with the primary innovators. The primary innovator may partner with the owner/creator of the co-creation ecosystem technology (e.g., Infosys™) and/or can engage with other entities as partners in innovation. The co-creation ecosystem shown may be a custom ecosystem configured for the needs of the primary innovator's innovation drive. Of course, any and/or all of the entities illustrated in FIG. 9 as well as others may be connected with the primary innovator via their co-creation ecosystem to participate in, collaborate with, and contribute to the primary innovator's innovation.

The various entities connected to a primary innovator via their co-creation ecosystem may strengthen their respective entity base strength by showcasing their capabilities and reaching a larger mass. Additionally, participation in innovation co-creation ecosystems may provide entities awareness of prominent happenings in the global innovation scene.

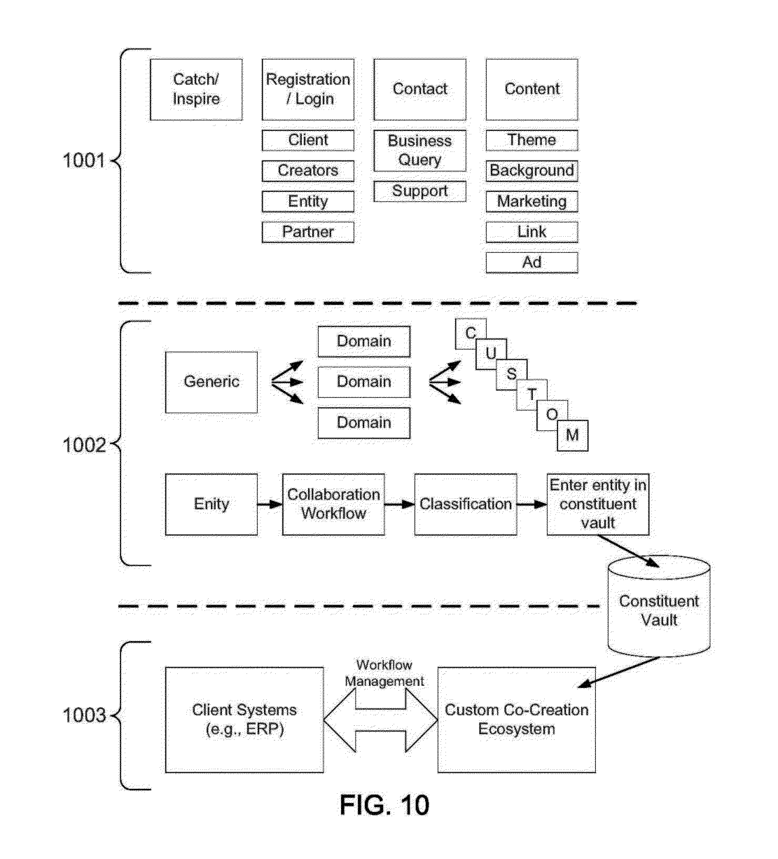

Of course, while the above described embodiments generally relate to designing, forming, hosting, and assessing a custom innovation co-creation ecosystem, technologies, systems, and architectures disclosed herein may be implemented in alternative fashions. For example, FIG. 10 illustrates a multi-tiered innovation co-creation ecosystem including a tier 1001 useful for marketing a co-creation platform, a tier 1002 useful for allowing potential constituents to test and familiarize themselves with the platform, and a tier 1003 useful for creating and managing a custom co-creation ecosystem.

Tier 1001 may provide a primary touch point for interested potential constituents. It may provide a marketing platform to catch and inspire constituents. It may also include a registration process for potentially interested constituents to register to test features of an exemplary innovation co-creation ecosystem. Constituents may register as various types of innovation co-creation constituents, such as clients (i.e., those who have a custom innovation co-creation ecosystem designed, generated, hosted, and/or managed for them), innovation co-creation system creators (e.g., Infosys™), entities that currently host co-creation systems that may benefit from integrating with custom innovation co-creation ecosystems, and potential co-creation partners. This tier may also provide a login space for registered interested potential constituents, as well as support to answer business queries regarding an ecosystem and support for using an ecosystem. Tier 1001 may also include a dynamic content space which may provide information such as innovation themes of exemplary innovation co-creation ecosystems, background information on the business benefits of innovation co-creation, general marketing materials (e.g., compact discs, pamphlets, etc.), links to exemplary materials, and ads (e.g., website ads) touting the benefits of innovation co-creation ecosystems.

Tier 1002 may provide an innovation co-creation ecosystem testing environment (e.g., a playground) to interested potential constituents to allow them to test the characteristics and benefits of an ecosystem. An interested potential constituent may be classified from a generic constituent, to the innovation domain they are interested in, to truly custom domains relevant to their innovation pursuits. A collaboration workflow may provide potential engagements, events, discussions, training and certifications, requirements news, and the like from core innovators and the like to illustrate to interested potential constituents the benefits of participating as constituents in co-creation ecosystems. In other words, tier 1002 allows interested potential constituents to explore other constituents, map and familiarize themselves with innovation initiatives, and see the value created through training, knowledge sharing, and other co-creation experiences. In tier 1002, an interested potential constituent may decide they want to enter in the constituent vault to make themselves available to join other entities' custom co-creation ecosystems or to design their own custom co-creation ecosystem.

Tier 1003 may provide design, generation, management, and other processes related to an innovation co-creation ecosystem, for example the processes described in relation to FIGS. 1-9 above. This tier may engage constituents from the vault with custom co-creation ecosystems in relevant innovation spaces, manage the engagements from a co-creation perspective, and evaluate performance of co-creation ecosystems at various levels. This tier may also provide workflows for the custom innovation co-creation ecosystem of a client to collaborate with other client systems (e.g., ERP systems).

Embodiments disclosed generally refer to the entity (e.g., an organization, a person, etc.) driving innovation as a primary innovator and the like. Co-creation constituents, co-creation partners, innovation stakeholders, and the like are generally used interchangeably. Finally, service providers, innovation co-creation ecosystem providers, and the like are used to interchangeably refer to the entity designing, hosting, and assessing a co-creation ecosystem.

Embodiments have been disclosed herein. However, various modifications can be made without departing from the scope of the embodiments as defined by the appended claims and legal equivalents.

What is claimed is:

1. A computer-implemented method for creating an innovation co-creation ecosystem by one or more computing devices, said method comprising:
designing, by at least one of the one or more computing devices, an innovation co-creation ecosystem for an innovation drive by a primary innovator;
providing, by at least one of the one or more computing devices, a co-creation constituent selection framework configured to assist the primary innovator with selection of a set of co-creation constituents; and
hosting, by at least one of the one or more computing devices, the innovation co-creation ecosystem.

2. The method of claim 1, further comprising:
managing the innovation co-creation ecosystem; and
assessing the innovation co-creation ecosystem performance.

3. The method of claim 1, wherein the step of designing the innovation co-creation ecosystem includes assessing the innovation co-creation readiness of the primary innovator.

4. The method of claim 1, wherein the step of designing the innovation co-creation ecosystem includes:
receiving data regarding the innovation drive from the primary innovator; and
generating a co-creation requirements analysis report.

5. The method of claim 4, wherein the step of designing the innovation co-creation ecosystem includes:
sending a survey to the primary innovator to inquire about the innovation drive;
receiving data regarding the innovation drive from the primary innovator;
generating a co-creation requirements analysis;
sending the co-creation requirements analysis to the primary innovator for validation;
receiving a validation identification;
updating the co-creation requirements analysis report if the validation is negative; and
outputting the co-creation requirements analysis if the validation is positive.

6. The method of claim 1, wherein the step of designing the innovation co-creation ecosystem includes generating a profile for potential innovation co-creation constituents.

7. The method of claim 6, wherein generating a profile for potential innovation co-creation constituents includes:
receiving a co-creation requirements analysis;
generating a constituent profile for a potential innovation co-creation constituent by performing one or more profiling function son the requirements analysis;
transmitting the constituent profile to the primary innovator for validation;
receiving a validation identification;
updating the constituent profile if the validation is negative; and
outputting the constituent profile if the validation is positive.

8. The method of claim 1, wherein the step of designing the innovation co-creation ecosystem further includes:
analyzing potential risks that could arise from an innovation partnership between the primary innovator and one or more co-creation constituent; and
generating a mitigation plan to minimize the potential risks.

9. The method of claim 1, wherein the step of providing the co-creation constituent selection framework includes generating a connect strategy.

10. The method of claim 1, wherein the step of providing the co-creation constituent selection framework includes providing a constituent search function.

11. The method of claim 10, wherein the constituent search function comprises:
receiving a profile for potential innovation co-creation constituents;
accessing a dataset of potential co-creation constituents form a network of potential co-creation constituents, the dataset including constituent profiles for the potential innovation co-creation constituents;
comparing the profile with the constituent profiles for the potential innovation co-creation constituents;
identifying one or more potential innovation co-creation constituents having constituent profiles matching the profile.

12. The method of claim 1, wherein the step of providing the co-creation constituent selection framework includes providing a process for the primary innovator to engage with a potential co-creation constituent.

13. A system for creating an innovation co-creation ecosystem by one or more computing devices, said system comprising:
a memory; and
a processor operatively coupled to the memory, the processor configured to perform the steps of:
designing an innovation co-creation ecosystem for an innovation drive by a primary innovator;
providing a co-creation constituent selection framework configured to assist the primary innovator with selection of a set of co-creation constituents; and
hosting the innovation co-creation ecosystem.

14. The system of claim 13, the processor further configured to perform the steps of:
managing the innovation co-creation ecosystem; and
assessing the innovation co-creation ecosystem performance.

15. The system of claim 13, wherein the step of designing the innovation co-creation ecosystem includes assessing the innovation co-creation readiness of the primary innovator.

16. The system of claim 15, wherein the step of designing the innovation co-creation ecosystem includes:
receiving data regarding the innovation drive from the primary innovator; and
generating a co-creation requirements analysis report.

17. Computer-readable code stored on a non-transitory computer-readable medium that, when executed by a computing device, performs the method:
designing an innovation co-creation ecosystem for an innovation drive by a primary innovator;
providing a co-creation constituent selection framework configured to assist the primary innovator with selection of a set of co-creation constituents;
hosting the innovation co-creation ecosystem;
managing the innovation co-creation ecosystem; and
assessing the innovation co-creation ecosystem performance.

18. The computer-readable medium of claim 17, wherein the step of designing the innovation co-creation ecosystem includes:
sending a survey to the primary innovator to inquire about the innovation drive;
receiving data regarding the innovation drive from the primary innovator;
generating a co-creation requirements analysis;
sending the co-creation requirements analysis to the primary innovator for validation;
receiving a validation identification;
updating the co-creation requirements analysis report if the validation is negative; and
outputting the co-creation requirements analysis if the validation is positive.

19. The computer-readable medium of claim 17, wherein the step of designing the innovation co-creation ecosystem includes generating a profile for potential innovation co-creation constituents.

20. The computer-readable medium of claim 17, wherein generating a profile for potential innovation co-creation constituents includes:
receiving a co-creation requirements analysis;
generating a constituent profile for a potential innovation co-creation constituent by performing one or more profiling function son the requirements analysis;
transmitting the constituent profile to the primary innovator for validation;
receiving a validation identification;
updating the constituent profile if the validation is negative; and
outputting the constituent profile if the validation is positive.
